(19) United States
(12) Patent Application Publication
(10) Pub. No.: US 2011/0270815 A1
(43) Pub. Date: Nov. 3, 2011

(54) EXTRACTING STRUCTURED DATA FROM WEB QUERIES

(75) Inventor: Xiao Li, Bellevue, WA (US)

(73) Assignee: Microsoft Corporation, Redmond, WA (US)

(21) Appl. No.: 12/770,778

(22) Filed: Apr. 30, 2010

(51) Int. Cl. G06F 17/30; G06F 15/18

(52) U.S. Cl. 707/706; 707/760; 706/12; 707/780; 706/52; 707/E17.044; 707/E17.108

(57) ABSTRACT

Described is processing a web query into structured data, such as for use in formulating a database query. A classifier and segmental conditional random field (CRF) model classify and segment a query into labeled segments used to obtain the structured data. The structured data includes a class, an intent set corresponding to data sought by the query, and an attribute set corresponding to an attribute name and attribute value representing each modifier in the query. The structured data may be converted into a query language (e.g., SQL) query to query the structured data source; e.g., the class may be used to select a database, the attribute set used to find one or more columns and a row in the database, and the intent set matched to a column, whose row data is the result being sought. A web search engine may return the database query as part of its results.

### BACKGROUND

Web queries are traditionally treated as bags of words/phrases. For example, most web search engines operate by finding matching documents based upon keywords.

This often leads to unsatisfactory web search experiences for users. Many times a user provides fairly specific information in a query seeking a particular answer, which humans can easily and intuitively understand, however contemporary search engines cannot. For example the terms “director” and “actors” in a query almost certainly mean that the user is seeking information about movies; if the query additionally includes a movie title (which often is made up of one or more common terms), then the user is seeking to know who directed and acted in the movie with that title.

However, because such keywords may be common among very many of documents, and because the query does not directly contain the keyword “movie,” many irrelevant documents may be returned. As search engine technology evolves, there is an increasing need for an improved understanding as to what a query is actually seeking, and for returning more relevant information based on that understanding.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a web query is processed into structured data, which may then be used to formulate a query for querying a structured data source such as a database, e.g., to provide results corresponding more closely to what a query was likely seeking. Based upon the query terms, a web query is classified by a classifier and segmented (e.g., by a segmental conditional random field model) into labeled segments, including one or more intent segments and one or more attribute segments. The classifier's classification may be influenced by the segmenting operation, resulting in a final classification.

The structured data includes a class, an intent set comprising one or more labeled segments corresponding to data sought by the query, and an attribute set comprising one or more labeled segments that each correspond to a type of attribute and a modifier of the query, e.g., an attribute name (type of attribute) and attribute value (the modifier of that type). The structured data may be converted into a query language (e.g., SQL) query to query the structured data source; for example, the class may be used to select a database, the intent set and attribute set used to determine columns within the selected database, and the attribute values used to find data in a row under the corresponding attribute column. With the row found, the intent set may be filled in with data that is in the same row under the intent column or columns, providing the results of the structured query. The results may be returned by the search engine, e.g., alone or in combination with conventional query results.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a representation of a web query being processed into structured data.

FIG. 2 is a representation of structured data extracted from a web query being converted into a query in a query language, which is then used to query a structured data source (e.g., a database).

FIG. 3 is a block diagram representing aspects related to training a segmental conditional random field model that is used in segmenting a web query into labeled segments for processing a web query into structured data.

FIG. 4 shows an illustrative example of a computing environment into which various aspects of the present invention may be incorporated.

### DETAILED DESCRIPTION

Various aspects of the technology described herein are generally directed towards processing an input query into structured data, which then may be used to formulate a structured query (e.g., in SQL) that often provides more relevant query results by querying a structured data source such as a database. To this end, a query is classified into a class so as to determine to which structured data source (if any) that query is to be directed, e.g., a movie database, (even if the query does not contain the term “movie”). The query is also processed into an intent set, corresponding to what information or action the query is seeking, and an attribute set comprising one or more attribute names and associated values based on narrowing information provided as modifiers in the query. The attribute set is then are used to locate data corresponding to the intent for returning as a response.

It should be understood that any of the examples herein are non-limiting. For example, while certain types of classifiers and models are described for use in transforming a query into structured query data, any suitable classifier and/or model may be used. Similarly, while SQL and a database are described as examples for use in obtaining results based upon the structured query data, any suitable query language or lookup mechanism for a given set of structured data may be used. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used in various ways that provide benefits and advantages in computing and query processing in general.

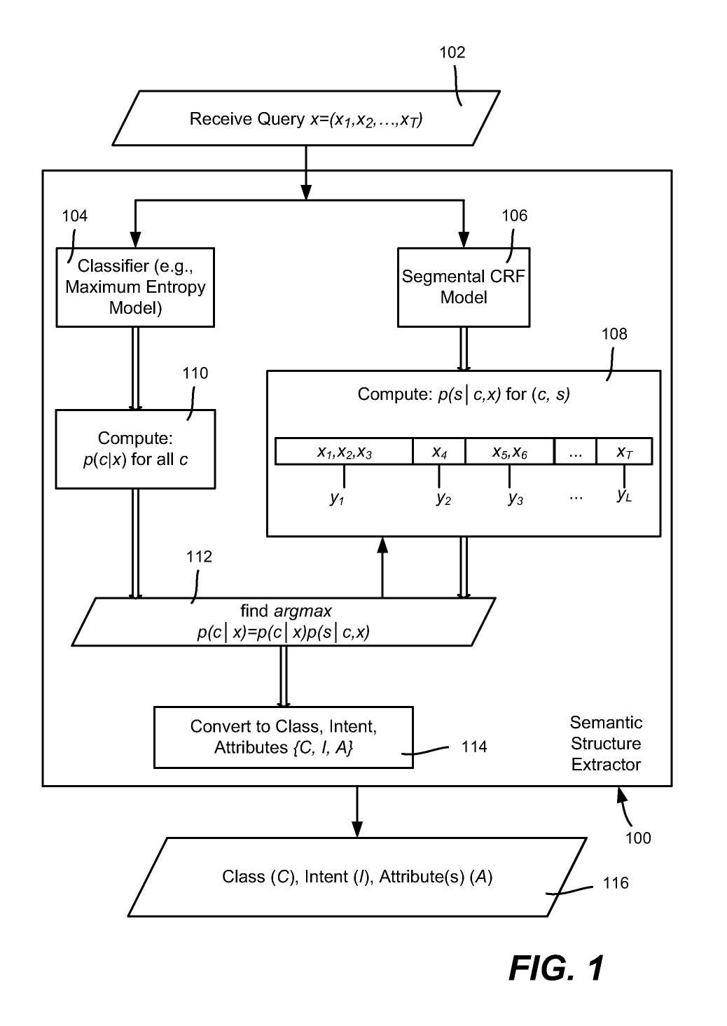

FIG. 1 is a block diagram showing a system (semantic structure extractor 100) for processing a query into a semantic structure. The semantic structure extractor 100 may be incorporated into or otherwise accessed by a web search engine. In one implementation, the semantic structure extractor 100 extracts the structure in the form of a tuple {C, I, A}, where C is the semantic class of a query; I is a set of one or more semantic intents in the form of {AttributeName}; and A is a set of one or more attributes in terms of {AttributeName=Attribute Value}.

In general, a query 102 is classified into the class C by a classifier 104, such as a maximum entropy model, boosted decision tree, neural network and so forth. For example, given example queries and a fixed number of classes from which to select, labeled training data may be used to train the classifier in a known supervised manner, possibly along with other semi-supervised and/or non-supervised training techniques. In one implementation, in online query processing usage, the classifier outputs probability data for each class, which may be used in determining the class, as described below.

As also represented in FIG. 1, the query 102 is segmented by a segmental conditional random field (CRF) model 106, (also referred to as a semi-Markov CRF), which outputs segments based upon the query terms along with labels assigned to the segments. By way of example, a query about a (hypothetical) movie may be received as “the football player 2009 director and cast” from a user. In this example, segmenting the query results in:

| Type | Label | Text |
|---|---|---|
| Attribute | Title | the football player |
| Attribute | Date | 2009 |
| Intent | Director | <TBD> |
| Other | — | and |
| Intent | Cast | <TBD> |

Note that there is an “other” type which may be applied to text that does not fit into an attribute or intent type, such as for prepositions, conjunctions, stopwords that are not part of something else, and so on. In this example, “and” fits such an Other type; however when appropriate, “and” may be segmented into a Title (or another) labeled segment, for example when part of “War and Peace”. Note further that “2009” is labeled with a “date” attribute in this example, however it may instead be part of a Title, e.g., for q query “movie 2012 box office”, the segment “2012” may be properly labeled as a Title (given a properly trained segmental CRF).

Thus, in the {C,I,A} structure, the class C corresponds to categories (categorical values), such as Job, Movie and so forth. The set of intents I refers to the information a user is querying to obtain, and/or an action that a user is seeking to take. The set of attributes A refers to a set of class-dependent attributes in the form of {AttributeName=Attribute Value}, serving as modifiers to the query. In other words, each attribute value falls under an attribute name, and is provided as a narrowing modifier in the query; in the above example, “2009” (which corresponds to a Date attribute name) and “the football player” (which corresponds to a Title attribute name for a hypothetical movie of that name) are the respective attribute values.

As one more particular example, again consider the query “the football player 2009 director and cast,” which after processing may have the following semantic structure (in the {C,I,A} structure format which is a different format from the table above):

C = Movie
I = {Director, Cast}
A = {Title = “the football player”, Date = “2009”}

In one implementation, the Class identifies a database table, and the labels of intents and attributes correspond to database column headers in that table. The attribute values correspond to data in a row under the attribute column headers. Thus, given a query with one intent and two attribute values, for example, the Class may be used to locate a database, and the attribute values used to find two columns and the row within those columns that contain the attribute values. The data in that row under the column that corresponds to the intent is what the query is seeking.

In the above example, the class C is used to select a Movie database table, and the Title and Date attribute names used to locate two columns in the database table. If there is a row in the table that contains “the football player” under the Title column, and “2009” under the Date column, then whatever data is under the Director column in that row is returned in response to the query, along with whatever data is under the Cast column in that row. Note that there is an implicit “AND” between attributes in this implementation.

As another example, the query “AbCorp software engineer jobs” may have the following semantic structure:

C = Job
I = {Job listing}
A = {Employer = “AbCorp”, JobType = “software engineer”}

By issuing this query, it is highly likely that the user wants to have data corresponding to the intent (Job listing) returned, given the modifier information in the attributes. The class is determined by classifying the query based on the words therein. The intent need not appear in the query, e.g., Job listing may be the segment label based upon the word “jobs” in this case.

Turning to details of extracting the semantic structure from a query using a classifier 104 and the segmental CRF 106, note that segmental CRFs model p(s|x), that is, a segmental CRF outputs a segmentation s of x along with a label assigned to each segment of one or more words; (this is different from traditional CRFs which assign labels to individual elements of a sequence). Consequently, segmental CRF defines features on segments rather than on individual elements.

Consider a query as a sequence of words x=(x₁, x₂, . . . , x_{T}) of length T. Block 108 in FIG. 1 shows an example segmentation computation, where y₁, y₂, . . . , y_{L}) represent the labels.

In conjunction with the classification computation p(c|x), as represented by block 110 in FIG. 1, given x, the task is to extract {C, I, A} using joint classification/sequence-labeling, p(c, s|x)=p(c|x)p(s|c, x). The task is to produces a classification c of the query, and a segmentation of the query with labels assigned to the segments, s=(s₁, s₂, . . . , s_{L}). In other words, two statistical models may be used to obtain the structured data, namely the classification model p(c|x), and the segmentation (parsing) model p(s|c, x).

With respect to classification, in one implementation, rather than simply selecting the most likely class via the classifier, the classifier outputs a number of candidate classes, each candidate class associated with a probability value. The segmental CRF model also may output probability data, that is, each segment may have an associated probability of being a Class segment. In one implementation, the probabilities of the classifier's class candidates are influenced by the segment-related probability data. For example, as represented by block 112 in FIG. 1, the maximum product of the classifier's candidate probabilities and the segment probability data may be used to select a final class:

argmax_{c,s}p(c, s|x)=p(c|x)p(s|c, x)

Other mechanisms may be used, including summing log probability data.

With respect to segmentation, each segment sᵢ comprises a tuple sᵢ=(uᵢ, vᵢ, yᵢ), representing the starting position uᵢ, then ending position vᵢ and the label yᵢ, respectively. In one implementation, each label yᵢ can be from the set {Intent, AttributeName1, AttributeName2, . . . , Other}. Once the class is known, the labels that are available for associating with the attribute segments are those that belong to the class. For example, in the movie domain (class), the set of labels may be (Category, Intent, Award, Character, Country, Date, Director, Genre, Gross, Name, Rating, Site, Title, . . . , Other).

The intent label (yᵢ=Intent) means that sᵢ refers to intent-related words. For example, in “movie 2012 box office”, the segment “box office” is labeled as Intent. The attribute label (yᵢ=AttributeNameⱼ) means that sᵢ is the value of the AttributeName. For example, in “movie 2012 box office”, the segment “2012” is labeled as Title; the segment “movie” is labeled as Category. The other label (yᵢ=Other) means that sᵢ comprises other words (neither class, attribute nor intent labels) as described above.

Once the class label and segment labels are obtained, the semantic structure may be expressed as:

C = c
I = {T(xᵤ_{ᵢ}_{:v}ᵢ): yᵢ = Intent}, where T is a transformation that converts the

text xᵤ_{ᵢ}_{:v}_{ᵢ} into a categorical value in AttributeName

A = {yᵢ = xᵤ_{ᵢ}_{:v}_{ᵢ}: yᵢ ∈ {AttributeName}

This straightforward transformation/conversion is represented by block 114 in FIG. 1, producing the class, intent set and attribute set in the structured data (tuple) form 116 as described herein.

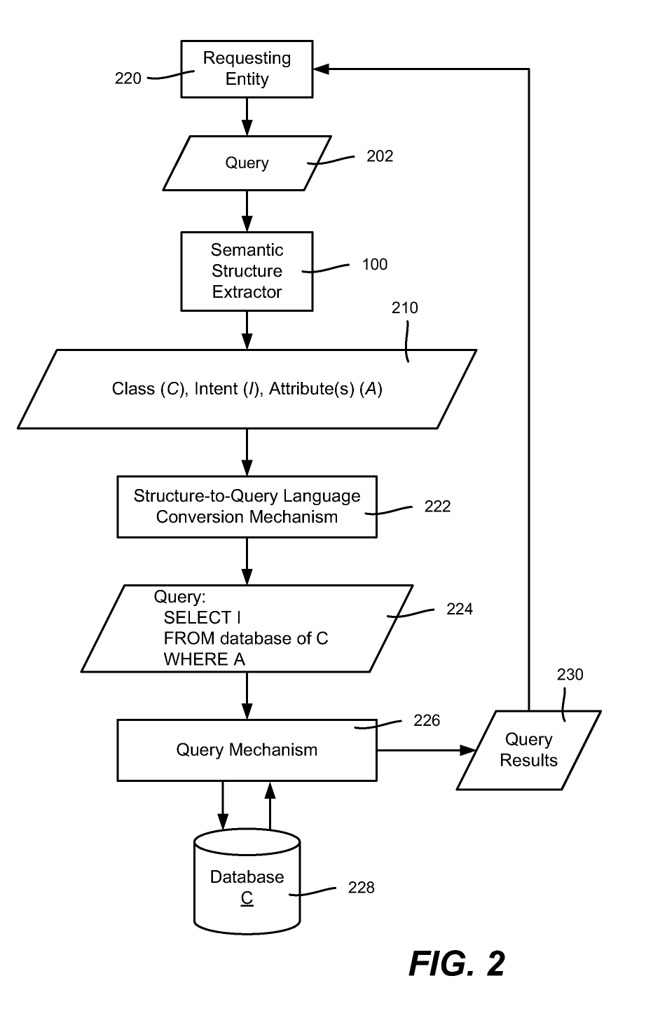

FIG. 2 represents a process for returning query results based upon the structure data, which includes converting the structured data to a structured query language for information retrieval. More particularly, some requesting entity such as a user or process 220 (e.g., of the search engine) provides a query 202. Using the above-described semantic structure extractor 100, the query is converted into a structured data 210, e.g., in the [C, I, A} form. Note that if this is not appropriate, e.g., there is no Class identified to a reasonable probability, the extractor 100 may return some indication as such, e.g., whereby a search engine or the like may return conventional search results.

A structure-to-query language conversion mechanism 222 processes the structured data 210 into a query language (e.g., SQL) query. To this end, given the semantic structure of a web query in form of [C, I, A}), it is straightforward using rules to convert it to a standard query language query 224 in a suitable query language such as SQL:

SELECT I
FROM database of C
WHERE A

For example, the above example query “the football player 2009 director and cast” has the following semantic structure:

C = Movie
I = {Director, Cast}
A = {Title = “the football player ”, Date = “2009”}

which may be converted to a SQL (or equivalent language) query as

SELECT Director, Cast
FROM Movie database
WHERE Title = “the football player” AND Date = “2009”

The query 224 can be issued by a query mechanism 226 to a database 228 (chosen by the class C) 228 for information retrieval. The query results 230 may be processed in any way, and returned to the requesting entity 220. For example, the query results may be merged in some suitable way onto a results page that includes conventional search results. If no results are found, (e.g., there is no movie with the title “the football player” in the database), conventional search results are returned.

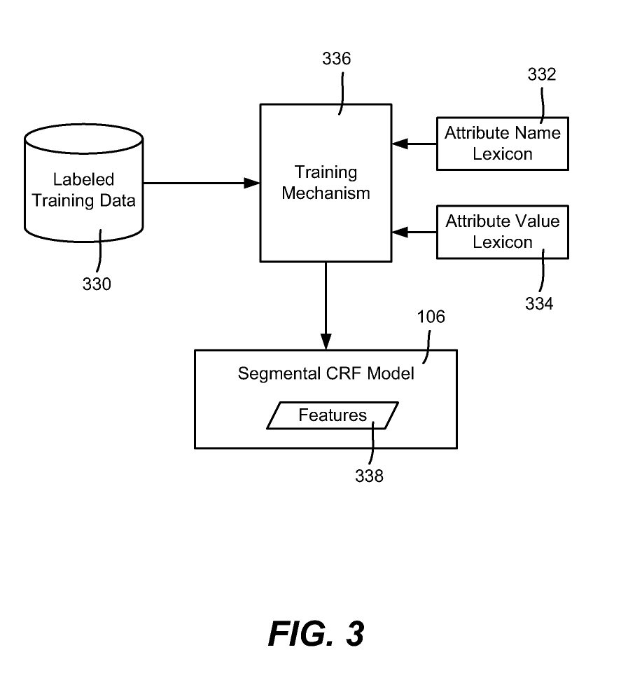

Turning to training the segmental CRF for semantic structure extraction, as generally represented in FIG. 3, a set of labeled training data 330 is used in one implementation, along with lexicons 332 and 334. More particularly, the training data is labeled with segment information, and the lexicons 332 and 334 include one lexicon of AttributeName entries, (analogous to the table column names), and a lexicon of AttributeValue data for each AttributeName (analogous to values and/or n-grams in the rows of a column), respectively.

The training mechanism 336 operates in a known manner, generally based upon various features found from within the training data versus those that may be computed from an actual future query that will need to be processed, e.g., by iterating to obtain feature weights that provide desired results against test data or the like. Example features 338 that may be incorporated into the segmental CRF model 106 for semantic structure extraction include an indicator function that indicates (e.g., zero if false, one if true) whether a segment exactly matches a segment phrase that occurred in the training. Another feature corresponds to an indicator function that indicates whether the segment exactly matches an item in a particular lexicon.

Other features may be used, including using normalized edit distance to determine how closely a segment matches a lexicon entry; stopwords may be removed, and stemming may be considered in the edit distance determination.

The well-known Tf-Idf (term frequency-inverse document frequency) score and/or other fuzzy match scores of the segment with respect to a matching item in a particular lexicon may be used as features. For example, “good” may fuzzily match “decent” with respect to product quality data.

Still other features may be based on transition features. For example, in a “music” classification, based upon the way people enter queries, there may be some measurable relationship between a next segment being “song” if the previous segment is “artist” and so on.

### Exemplary Operating Environment

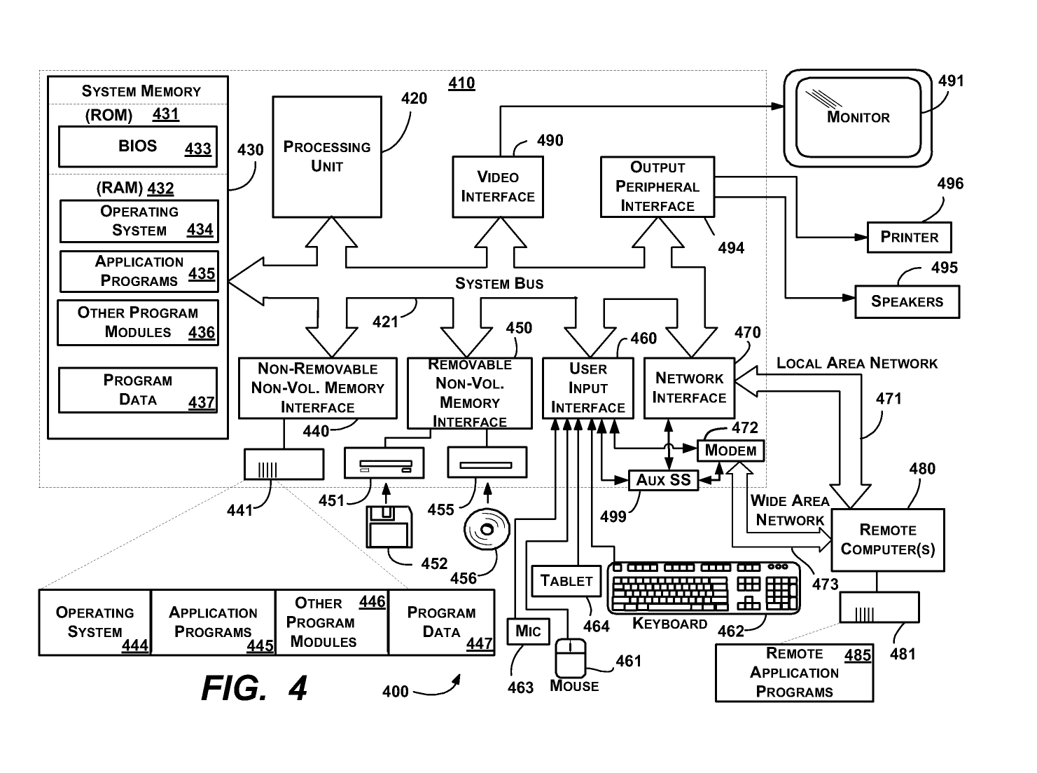

FIG. 4 illustrates an example of a suitable computing and networking environment 400 on which the examples of FIGS. 1-3 may be implemented. The computing system environment 400 is only one example of a suitable computing environment and is not intended to suggest any limitation as to the scope of use or functionality of the invention. Neither should the computing environment 400 be interpreted as having any dependency or requirement relating to any one or combination of components illustrated in the exemplary operating environment 400.

The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 4, an exemplary system for implementing various aspects of the invention may include a general purpose computing device in the form of a computer 410. Components of the computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 410 typically includes a variety of computer-readable media. Computer-readable media can be any available media that can be accessed by the computer 410 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 410. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436 and program data 437.

The computer 410 may also include other removable/non-removable, volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media, described above and illustrated in FIG. 4, provide storage of computer-readable instructions, data structures, program modules and other data for the computer 410. In FIG. 4, for example, hard disk drive 441 is illustrated as storing operating system 444, application programs 445, other program modules 446 and program data 447. Note that these components can either be the same as or different from operating system 434, application programs 435, other program modules 436, and program data 437. Operating system 444, application programs 445, other program modules 446, and program data 447 are given different numbers herein to illustrate that, at a minimum, they are different copies. A user may enter commands and information into the computer 410 through input devices such as a tablet, or electronic digitizer, 464, a microphone 463, a keyboard 462 and pointing device 461, commonly referred to as mouse, trackball or touch pad. Other input devices not shown in FIG. 4 may include a joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. The monitor 491 may also be integrated with a touch-screen panel or the like. Note that the monitor and/or touch screen panel can be physically coupled to a housing in which the computing device 410 is incorporated, such as in a tablet-type personal computer. In addition, computers such as the computing device 410 may also include other peripheral output devices such as speakers 495 and printer 496, which may be connected through an output peripheral interface 494 or the like.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 4. The logical connections depicted in FIG. 4 include one or more local area networks (LAN) 471 and one or more wide area networks (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460 or other appropriate mechanism. A wireless networking component such as comprising an interface and antenna may be coupled through a suitable device such as an access point or peer computer to a WAN or LAN. In a networked environment, program modules depicted relative to the computer 410, or portions thereof, may be stored in the remote memory storage device. By way of example, and not limitation, FIG. 4 illustrates remote application programs 485 as residing on memory device 481. It may be appreciated that the network connections shown are exemplary and other means of establishing a communications link between the computers may be used.

An auxiliary subsystem 499 (e.g., for auxiliary display of content) may be connected via the user interface 460 to allow data such as program content, system status and event notifications to be provided to the user, even if the main portions of the computer system are in a low power state. The auxiliary subsystem 499 may be connected to the modem 472 and/or network interface 470 to allow communication between these systems while the main processing unit 420 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method performed on at least one processor comprising, processing a web query into structured data, including classifying the query and segmenting the query into labeled segments, the structured data including a class, an intent set comprising one or more labeled segments corresponding to data sought by the query, and an attribute set comprising one or more labeled segments that each correspond to a modifier of the query.

2. The method of claim 1 wherein classifying the query comprises determining the class based upon classification results of a classifier.

3. The method of claim 1 wherein classifying the query comprises selecting a class based on probability data provided by a classifier, and probability data associated with one or more of the labeled segments.

4. The method of claim 1 further comprising, converting the structured data into a structured query of a query language, querying a database with the structured query, and returning results.

5. The method of claim 4 further comprising, using the class to determine the database from among a plurality of databases, using the intent set to determine one or more columns in the database, and using the attribute set to determine one or more other columns in the database and data within those one or more other columns.

6. The method of claim 1 wherein segmenting the query comprises labeling each segment with an intent, attribute or other name label.

7. The method of claim 1 wherein processing the web query comprises obtaining the intent set and attribute set from a segmental conditional random field model.

8. The method of claim 1 further comprising, training the segmental conditional random field model with labeled training data including segment information, and attribute name and attribute value lexicons.

9. In a computing environment, a system comprising, a semantic structure extractor, including a classifier that classifies a query into classification-related data, a segmental conditional random field model that segments the query into segment-related data including a label for each segment, a mechanism for selecting a class based upon the classification-related data and the segment-related data, the semantic structure extractor providing structured data comprising the class, an intent set comprising one or more labeled segments corresponding to data sought by the query, and an attribute set comprising one or more labeled segments that each correspond to a modifier of the query, in which each label of a segment the attribute set correspond to the class.

10. The system of claim 9 wherein the classifier comprises a maximum entropy classifier, a boosted decision tree classifier, or a neural network classifier.

11. The system of claim 9 wherein the mechanism for selecting a class based upon the classification-related data and the segment-related data uses probability data provided by the classifier and other probability data provided by the segmental conditional random field model.

12. The system of claim 9 wherein the segmental conditional random field model uses one or more features, including an indicator function that indicates whether a segment contains a n-gram that occurred in training, or an indicator function that indicates whether a segment exactly matches a segment phrase that occurred in the training, or both an indicator function that indicates whether a segment contains a n-gram that occurred in training and an indicator function that indicates whether the segment exactly matches a segment phrase that occurred in the training.

13. The system of claim 9 wherein the segmental conditional random field model uses one or more features, including an indicator function that indicates whether a segment exactly matches an item in a particular lexicon.

14. The system of claim 9 wherein the segmental conditional random field model uses one or more features, including normalized edit distance, a Tf-Idf score or a fuzzy match score of at least one segment with respect to a matching lexicon item, or any combination of normalized edit distance, a Tf-Idf score or a fuzzy match score of at least one segment with respect to a matching lexicon item.

15. The system of claim 9 further comprising, a mechanism that converts the structured data into a structured query for querying a database.

16. The system of claim 9 wherein the semantic structure extractor is incorporated into a web search engine or accessed by a web search engine.

17. In a computing environment, a system comprising:
a web search engine that receives a web query;
a semantic structure extractor that receives at least part of the web query from the web search engine and converts the web query into structured data including a class, an intent set comprising one or more labeled segments corresponding to data sought by the query, and an attribute set comprising one or more labeled segments that each correspond to a modifier of the query, the semantic structure extractor determining the class based upon terms in the query, and determining labels for the segments based upon the class and the terms in the query; and
a mechanism that uses the structured data to query a source of structured data to provide results from the source of structured data to the web search engine.

18. The system of claim 17 wherein the semantic structure extractor includes a classifier for use in determining the class.

19. The system of claim 17 wherein the semantic structure extractor includes a segmental conditional random field model for use in obtaining the labeled segments.

20. The system of claim 17 wherein the web search engine returns a results page including results from the source of structured data in response to the web query.
